(19) United States
(12) Patent Application Publication
(10) Pub. No.: US 2013/0174250 A1
(43) Pub. Date: Jul. 4, 2013

(54) ELECTRONIC DEVICE AND METHOD FOR RESTRICTING ACCESS TO THE ELECTRONIC DEVICE UTILIZING BIOS PASSWORD

(71) Applicant: MING-YI CHEN, Shenzhen City (CN)

(72) Inventor: MING-YI CHEN, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD, Shenzhen City (CN)

(21) Appl. No.: 13/607,778

(22) Filed: Sep. 9, 2012

(30) Foreign Application Priority Data
Dec. 29, 2011 (CN) 201110453815.1

(51) Int. Cl. G06F 21/00

(52) U.S. Cl. 726/18

(57) ABSTRACT

A method for restricting access to an electronic device using basic input output system (BIOS) password comprises: generating a first window on a display to receive a first user input in response to a password pre-setting input via an input module; formatting the first user input into American Standard Code for Information Interchange (ASCII); and writing the ASCII into a BIOS chip as the preset password. The electronic device is also provided.

### BACKGROUND

1. Technical Field

The present disclosure relates to electronic devices and particularly to an electronic device and method for restricting access to the electronic device using basic input output system (BIOS) password.

2. Description of Related Art

BIOS passwords may be used to restrict access to computers. Normally, BIOS software is stored on a non-volatile read-only memory (NVROM) chip and BIOS settings including a preset password are stored in a complementary metal oxide semiconductor (CMOS) memory of the computer's Southbridge chip. When the computer starts, the BIOS software is firstly run and reads the BIOS settings from the CMOS memory to initialize the computer. During this process, the BIOS compares user inputs with the preset password to allow authorized access and reject unauthorized access. However, the CMOS memory is typically powered by a CMOS battery. By interrupting the power supply of the battery, the BIOS settings can be reverted to default values, disabling the BIOS password.

Therefore, it is desirable to provide an electronic device and a method for restrict access to the electronic device, which can overcome the above-mentioned shortcomings.

### BRIEF DESCRIPTION OF THE DRAWINGS

FIG. 1 is a functional block diagram of an electronic device, according to an embodiment.

FIG. 2 is a schematic diagram of a first window of the electronic device in response to a password pre-setting input, to indicate to input a password as a preset password of FIG. 1.

FIG. 3 is a schematic diagram of a second window to indicate to input a password before being allowed to access the electronic device of FIG. 1.

FIG. 4 is a schematic diagram of a third window to indicate to reenter the password of FIG. 3.

FIG. 5 is a schematic diagram of a fourth window to indicate that times of reentering the password is exceeded.

FIG. 6 is a flowchart showing a method for pre-setting a password according to an embodiment.

FIG. 7 is a flowchart showing a method for restricting access to an electronic device according to an embodiment.

### DETAILED DESCRIPTION

Embodiments of the disclosure will be described with reference to the accompanying drawings.

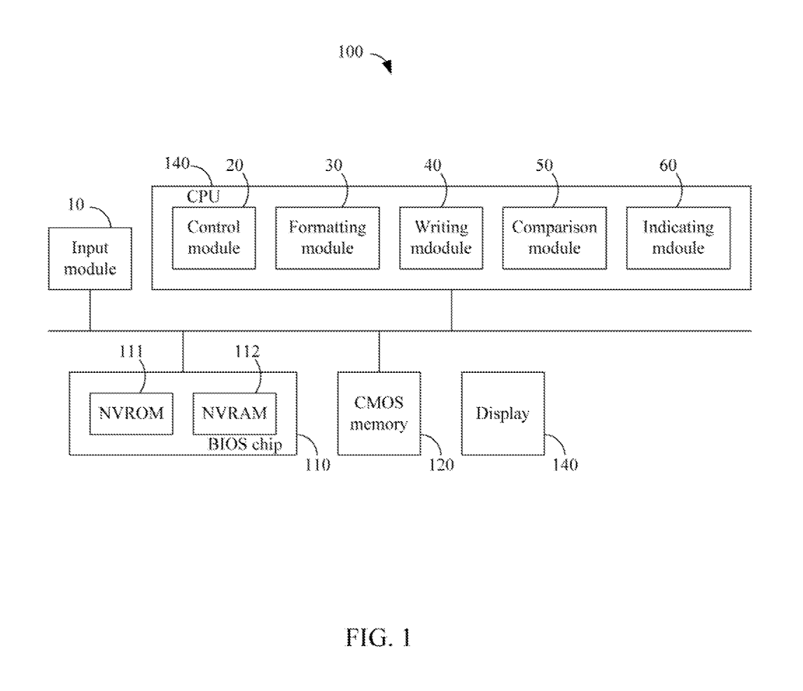

Referring to FIG. 1, an electronic device 100, such as a desktop or a laptop, includes a BIOS chip 110 and a CMOS memory 120. The BIOS chip includes a first memory 111 and a second memory 112. The first memory 111 can be a NVROM and is configured to store BIOS software. The second memory 112 can be a non-volatile random access memory (NVRAM) 112, such as a flash memory, and is configured to store a preset password. In alternative embodiments, the first and the second memories 111, 112 can both be a NVRAM and can be integrated into one unit, in which a segment is designated to store the preset password. The CMOS memory 112 is configured to store BIOS settings.

The electronic device 100 also includes a central processing unit (CPU) 130 and a display 140. When the electronic device 100 starts, the BIOS software is firstly run on the CPU 130 which reads the preset password and the BIOS settings to initialize the electronic device 100.

The electronic device 100 includes an input module 10, a control module 20, a formatting module 30, a writing module 40, a comparison module 50, and an indicating module 60.

The input module 10, such as a keyboard, receives user inputs.

The control module 20, the formatting module 30, the writing module 40, the comparison module 50, and the indicating module 60 can be software modules of the BIOS software and perform the below-described functions when executed on the CPU 130.

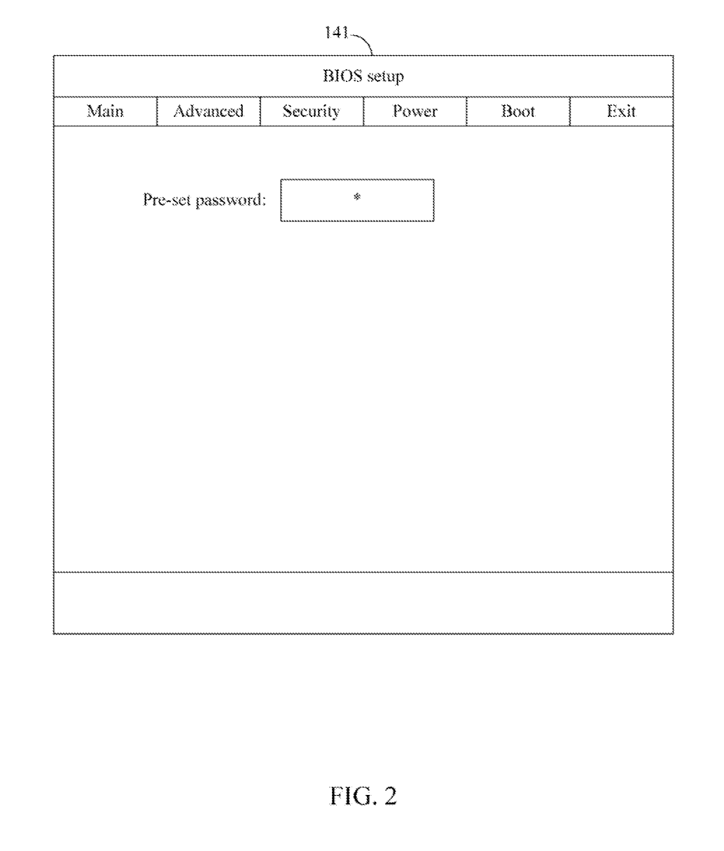

The control module 20, when triggered by a password pre-setting input via the input module 10, generates a first window 141 (see FIG. 2) on the display 140 for receiving a first user input (e.g., a sequence of characters and/or digits) via the input module 10 as a preset password. The password pre-setting input takes place after a predetermined key, such as “Del” key, is pressed.

The formatting module 30 formats the first user input into American Standard Code for Information Interchange (ASCII).

The writing module 40 writes the ASCII into NVRAM 112 as the preset password. The writing module 40 can write the formatted first user input into other suitable memories as one or more backups of the preset password.

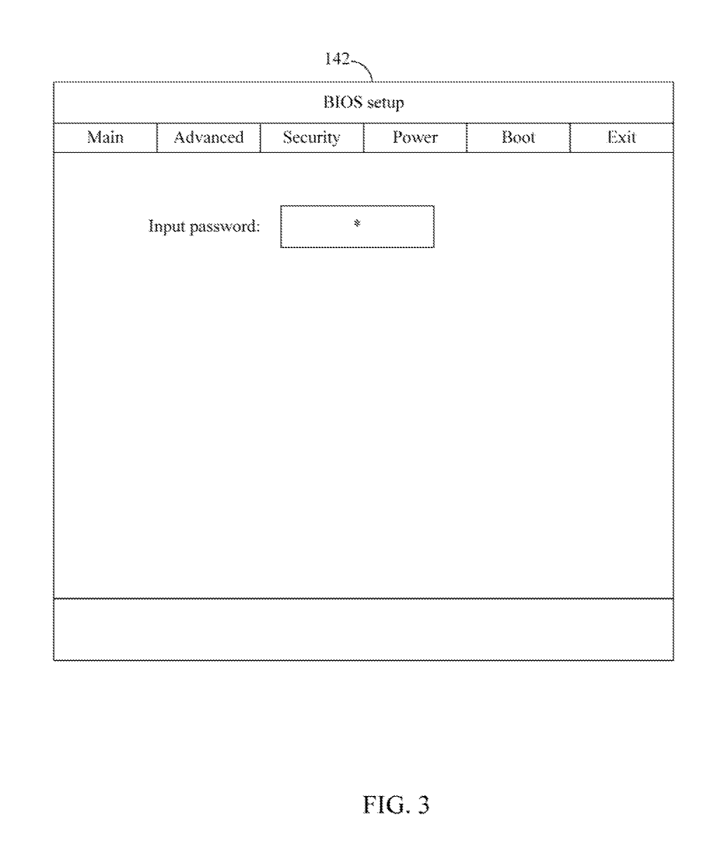

The control module 30 is also configured to generate a second window 142 (see FIG. 3) on the display 140 to indicate to input a password before being allowed to access the electronic device 100 and receive a second user input via the input module 10.

The comparison module 50 compares the second user input with the preset password. The comparison module 50 also allows access to the electronic device 100 upon a condition that the second user input is identical to the preset password and rejects access to the electronic device 100 upon a condition that the second user input is not identical to the preset password.

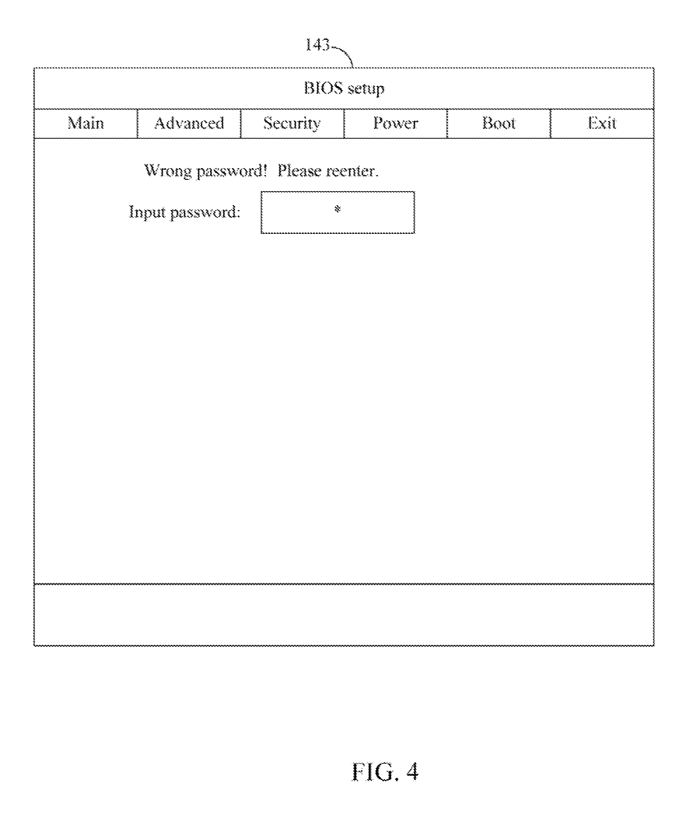

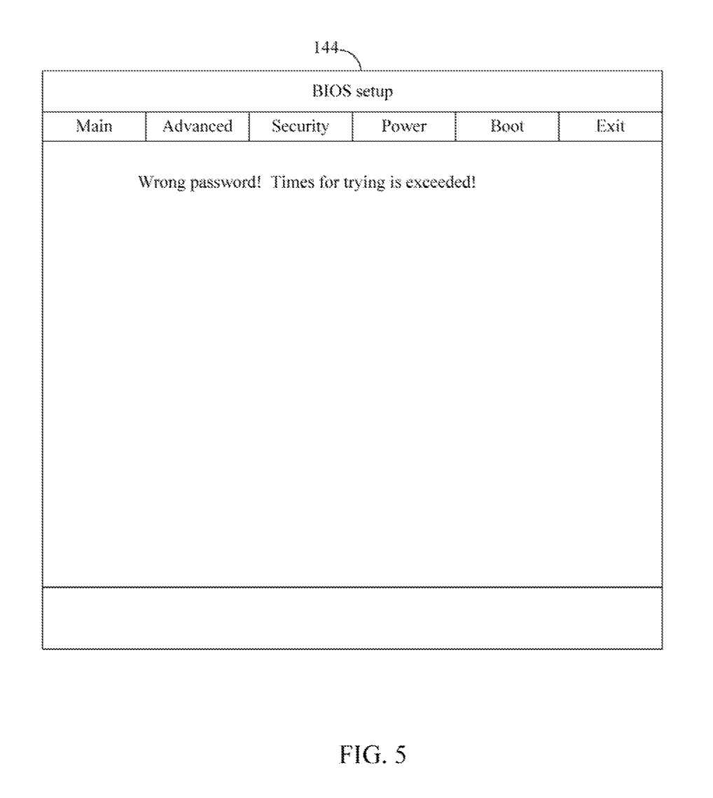

The indicating module 60 generates a third window 143 (see FIG. 4) on the display 140 to indicate to reenter the preset password upon the condition that the second user input is not identical to the preset password and a fourth window 144 (see FIG. 5) on the display 140 indicating that times of reentering the password is exceeded when times of reentering the password exceed a predetermined number, e.g., three times.

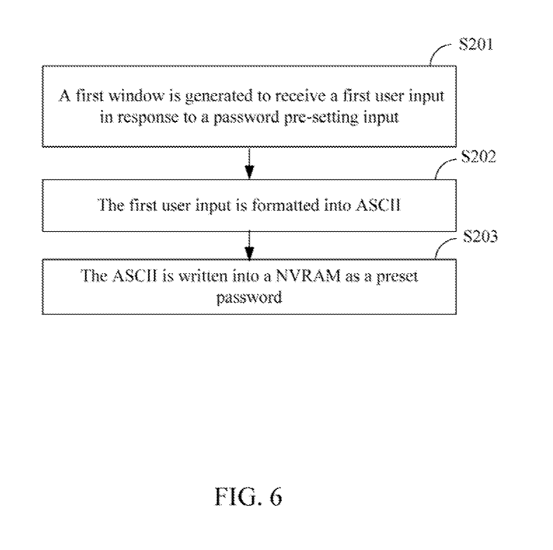

FIG. 6 is a method for pre-setting a preset password according to an embodiment.

In step S201, the first window 141 is generated in response to the password pre-setting input via the input module 10 for receiving a first user input.

In step S202, the second user input is formatted into ASCII.

In step S203, the formatted second user input is written into the NVRAM 112 as the preset password and can be written into other suitable memories of the electronic device 10 for backup purposes.

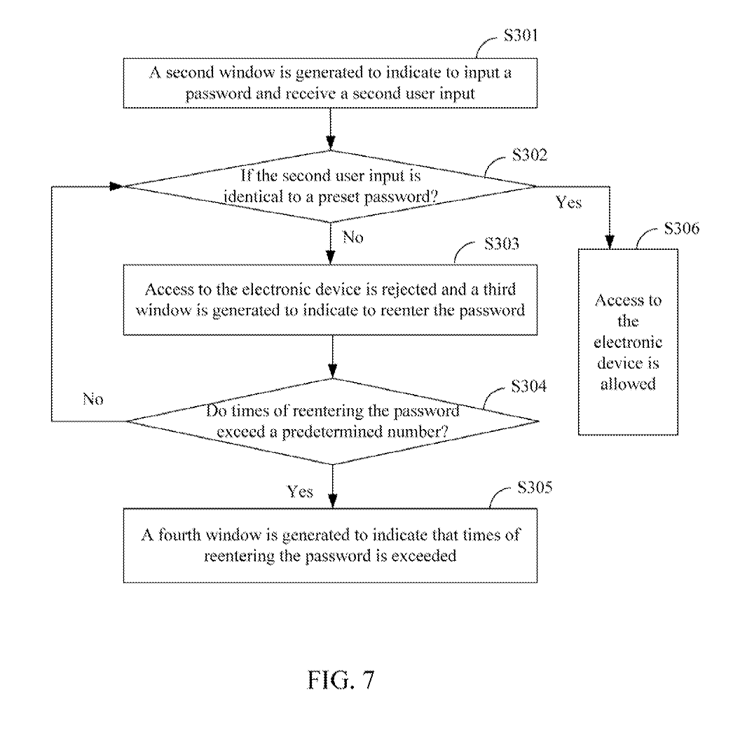

FIG. 7 is a method for restricting access to an electronic device according to an embodiment.

In step S301, the second window 142 is generated to indicate to input the password and receive the second user input.

In step S302, the second user input is compared with the preset password. If second third user input is identical to the preset password, the procedure goes to the step S306, otherwise, the flow of the method jumps to the step S303.

In step 303, access to the electronic device 200 is rejected and the third window 143 is generated to indicate to reenter the password.

In step 304, times of reenter the password is compared with the predetermined number. If times of reentering the password exceed the predetermined number, the procedure goes to the step S305, otherwise, the flow of the method jumps to the step S302.

In step 305, the fourth window 144 is generated to indicate that times of reentering the password is exceeded.

In step S306, access to the electronic device 100 is allowed.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An electronic device for restricting access to the electronic device using basic input output system (BIOS) password, comprising:
a display;
a BIOS chip storing BIOS software and a preset password;
a central processing unit (CPU), to run the BIOS software and read the preset password and the BIOS settings to initialize the electronic device;
an input module, to receive user inputs;
a control module, to generate a first window on the display to receive a first user input in response to a password pre-setting input;
a formatting module, to format the first user input into American Standard Code for Information Interchange (ASCII); and
a writing module, to write the ASCII into the BIOS chip as the preset password.

2. The electronic device according to claim 1, wherein the BIOS chip comprises a first memory and a second memory, the first memory is a non-volatile read-only memory (NVROM) and configured to store the BIOS software, the second memory is a non-volatile random access memory (NVRAM) to store the preset password.

3. The electronic device according to claim 1, wherein the BIOS chip comprises a first memory and a second memory, the first memory is a non-volatile random access memory (NVRAM) and configured to store the BIOS software, the second memory is also a NVRAM to store the preset password.

4. The electronic device according to claim 1, wherein the control module generates a second window on the display to indicate to input a password before being allowed to access the electronic device and receives a second user input via the input module, the comparison module compares the second user input with the preset password, allows access to the electronic device upon a condition that the second user input is identical to the preset password, and rejects access to the electronic device upon a condition that the second user input is not identical to the preset password.

5. The electronic device according to claim 4, wherein the indicating module generates a third window on the display to indicate to reenter the preset password upon the condition that the second user input is not identical to the preset password.

6. The electronic device according to claim 5, wherein the indicating module generates a fourth window on the display indicating that times of reentering the password is exceeded when times of reentering the password exceed a predetermined number.

7. The electronic device according to claim 1, wherein the writing module writes the ASCII into other suitable memories of the electronic device as backups of the preset password.

8. A method for restricting access to an electronic device using basic input output system (BIOS) password, the electronic device comprising a display, a basic input output system (BIOS) chip storing BIOS software and a preset password, and a central processing unit (CPU) to run the BIOS software and read the preset password and the BIOS settings to initialize the electronic device, the method comprising:
generating a first window on the display to receive a first user input in response to a password pre-setting input via an input module;
formatting the first user input into American Standard Code for Information Interchange (ASCII); and
writing the ASCII into the BIOS chip as the preset password.

9. The method for restricting access to an electronic device according to claim 8, wherein the BIOS chip comprises a first memory and a second memory, the first memory is a non-volatile read-only memory (NVROM) and configured to store the BIOS software, the second memory is a non-volatile random access memory (NVRAM) to store the preset password.

10. The method for restricting access to an electronic device according to claim 8, wherein the BIOS chip comprises a first memory and a second memory, the first memory is a non-volatile random access memory (NVRAM) and configured to store the BIOS software, the second memory is also a NVRAM to store the preset password.

11. The method for restricting access to an electronic device according to claim 8, further comprising generating a second window on the display to indicate to input a password before being allowed to access the electronic device and receives a second user input via the input module, comparing the second user input with the preset password, allowing access to the electronic device upon a condition that the second user input is identical to the preset password, and rejecting access to the electronic device upon a condition that the second user input is not identical to the preset password.

12. The method for restricting access to an electronic device according to claim 11, further comprising generating a third window on the display to indicate to reenter the preset password upon the condition that the second user input is not identical to the preset password.

13. The method for restricting access to an electronic device according to claim 12, further comprising generating a fourth window on the display indicating that times of reentering the password is exceeded when times of reentering the password exceed a predetermined number.

14. The method for restricting access to an electronic device according to claim 8, further comprising writing the ASCII into other suitable memories of the electronic device as backups of the preset password.
